(19) United States
(12) Patent Application Publication
(10) Pub. No.: US 2026/0169143 A1
(43) Pub. Date: Jun. 18, 2026

(54) A MULTISTATIC RADAR SYSTEM

(71) Applicant: SAAB AB, Linköping (SE)

(72) Inventors: Anders SILANDER, Göteborg (SE); Pontus JOHANNISSON, Mölndal (SE)

(21) Appl. No.: 19/125,807

(22) PCT Filed: Oct. 19, 2023
(86) PCT No.: PCT/SE2023/051038

§ 371 Date: Apr. 30, 2025

(30) Foreign Application Priority Data
Nov. 3, 2022 (SE) 2200124-2

(51) Int. Cl. G01S 13/00; G01S 13/42; G01S 13/91

(52) U.S. Cl. CPC G01S 13/003; G01S 13/42; G01S 13/91

(57) ABSTRACT

The present disclosure relates to a multistatic radar system including a transmitting radar node configured to transmit MIMO signals having unique spatial signatures, wherein each spatial signature of the unique spatial signatures is associated to a specific transmitting direction. The system includes a receiving radar node being separated relative the transmitting radar node and control circuitry. The receiving radar node is configured to receive reflected signals from the transmitting node. The control circuitry is configured to determine direction of arrival and time of arrival of each of the signals reflected from the target. The system is configured to determine direction of departure and derive navigation data for monitoring the target relative the transmitting radar node and the receiving radar node and/or monitoring the transmitting radar node relative the receiving radar node.

### TECHNICAL FIELD

The present disclosure relates to a multistatic radar system, a method for monitoring a target relative a transmitting radar node and a receiving radar node and/or monitoring the transmitting radar node relative the receiving radar node and a computer-readable storage medium for performing the method.

### BACKGROUND

A multistatic radar system comprises multiple spatially diverse monostatic radar or bistatic radar components with a shared area of coverage. In a multistatic radar system, the radar nodes collaborate to detect targets. Accurate navigation is of central importance, however it is challenging to provide such for multistatic radar systems, especially when the multistatic radar system comprises airborne radar nodes.

Conventional solutions such as Global navigation satellite systems (GNSS), provide position information but are easily disrupted. Inertial navigation is (without GNSS) subject to error accumulation over time. Generally, conventional solutions are dependent on external support systems.

Thus, multistatic radar systems in the present art fail to fulfil requirements of accuracy and reliability.

Specifically, multistatic radar systems fail to fulfil requirements of accuracy and reliability without supplementary navigation systems.

Thus, there is room for multistatic radar systems in the present art to explore the domain of providing a multistatic radar system that provides improved accuracy and reliability to conventional radar systems, specifically when used without supplementary navigation systems, e.g., in a GNSS-denied environment.

Even though previous solutions may work well in some situations, it would be desirable to provide a multistatic radar system that addresses requirements related to improving accuracy and reliability of the multistatic radar system compared to other multistatic radar systems.

### SUMMARY

It is therefore an object of the present disclosure to alleviate at least some of the mentioned drawbacks to provide an improved multistatic radar system that is more accurate and reliable compared to conventional multistatic radar systems.

This and other objects, which will become apparent in the following, are achieved by a multistatic radar system, a method and computer-readable storage medium as defined in the appended claims.

The present disclosure relates to a multistatic radar system comprising a transmitting radar node configured to transmit multiple-in multiple-out (MIMO) signals. Each MIMO signal having unique spatial signatures, wherein each spatial signature of said unique spatial signatures is associated to a specific transmitting direction. The system further comprises a receiving radar node being spatially separated relative the transmitting radar node and control circuitry. The receiving radar node is configured to receive reflected signals from said transmitting node said signals being reflected from a target. Further, the control circuitry is configured to determine direction of arrival (DOA) and time of arrival (TOA) of said signals reflected from the target.

Further, the control circuitry is configured to determine, based on the spatial signature of said reflected signal, direction of departure (DOD) of said signals transmitted from the transmitting radar node. Moreover the control circuitry is configured to derive navigation data, based on the determined DOA, TOA and DOD, the navigation data may be utilized to monitor the target relative the transmitting radar node and the receiving radar node and/or monitoring the transmitting radar node relative the receiving radar node. Thus, the control circuitry may further be configured to monitor the target relative the transmitting radar node and the receiving radar node and/or monitoring the transmitting radar node relative the receiving radar node.

The system provides the advantage of reliable and accurate navigation of targets and components within the system. In other words, the system advantageously provides, additional parameters compared to other systems. Accordingly, the system utilizing the obtained parameters (DOA, TOA, and DOD of transmitted signal) can achieve a more reliable and accurate monitoring of targets relative the transmitting radar node and the receiving radar node (i.e. relative the system as such) and monitoring the transmitting radar node relative the receiving radar node.

The MIMO signals comprise unique spatial signatures by signal modulation, signal modulations being one of frequency modulation, amplitude modulation, phase modulation, slow-time MIMO, fast-time MIMO, a combination thereof, or any other suitable type of modulation of each antenna element, or signal transmitted therefrom. Each signal may be defined as a pulse train or a continuous modulated waveform. For example, a unique spatial signature may be a specific modulation for a specific first signal (first pulse train). Thus, another second MIMO signal may have different spatial signature, e.g. a specific modulation differing from the phase shift of the first signal, or a modulation differing from the modulation of the first MIMO signal. The unique spatial signatures may be dependent/indicative of the physical orientation (e.g. antenna arrangement at the time of transmitting signals) of the transmitting radar node.

Each MIMO signal transmitted from the transmitting radar node may be associated to (indicative of) a specific transmitting direction (DOD) when received at the receiving radar node. The transmitting radar node may be configured to transmit a MIMO signal from antenna elements thereof in which each antenna element transmits a different signal (or at least one element transmits a different signal compared to the other elements). The relationship/correlation between direction (e.g. DOD) and spatial signature may be stored in/accessible by the control circuitry, e.g. in a lookup table thereof. For example, the control circuitry may obtain from the receiving radar node that a reflected signal having a spatial signature x has been received. Based on this, the control circuitry may derive the direction of departure based on the spatial signature x. Alternatively, waveform information (or a references to specific waveforms in a lookup table) may be communicated from the transmitting radar node during operation. The spatial signature x may be determined from a received MIMO signal. It should be noted that the control circuitry may store/have access to the physical structure of the transmitting radar node such as number of antenna elements and distance between antenna elements. Accordingly, when said receiving radar node receives a MIMO signal, the receiving radar node may, individually for each MIMO signal, derive the DOD by recovering the different waveforms received in said MIMO signal and determine phase data of the signal, based on said phase data that comprises phase information of each antenna element (or signal transmitted therefrom), the DOD may be derived.

An advantage of this is that it further increases the accuracy and reliability of the system herein.

The transmitting radar node may further be configured to transmit signals directly to said receiving radar node, based on the transmitted direct signals, the control circuitry is configured to determine DOA and TOA of said directly transmitted signals, and determine, based on the spatial signature of said directly transmitted signal, DOD of said directly transmitted signals.

The receiving radar node may be configured to, prior to/in addition to calculating navigation data, estimate, based on said reflected signals and said signals transmitted directly to said receiving node, a clock difference of said transmitting radar node and said receiving radar node and/or the receiving radar node may receive a plurality of reflected signals from a plurality of targets and estimate, based on said plurality of reflected signals, said clock difference of said transmitting radar node and said receiving radar node. Thus, the clock difference may be estimated in two alternative manners depending on available data for the control circuitry. The clock difference may be estimated by trilateration. Thus, based on the obtained plurality of DOA, DOD, TOA parameters, the control circuitry may determine said clock difference between said transmitting radar node and receiving radar node. In some aspects, the clock difference may be pre-calibrated/determined, therefore the step of determining clock difference may in some aspects herein be omitted. The determination of the clock difference may be made by statistical methods such as Maximum likelihood, Maximum A posteriori or any other suitable statistical method. The control circuitry may comprise the step of compensating for said clock difference for achieving time synchronization between the nodes. The system may be configured to determine clock difference iteratively at specific intervals as the clock difference can be altered by e.g., temperature, humidity, radio interferences or other environmental or hardware factors. The clocks may be synchronized relative each other or relative a reference clock.

By determining clock difference between the nodes, the parameters, specifically TOA can be determined with a greater accuracy. Thus, the navigation data as such is more reliable and accurate.

DOA and DOD may each be determined in azimuth angle and elevation angle.

The navigation data may comprise orientation angles of said transmitting and/or receiving radar node, respectively, and/or position of said receiving radar node relative said transmitting radar node and/or said target. The orientation angles may comprise roll, pitch and heading angles of each node. The orientation angle (heading angle) may refer to a coordinate system relative earth or another static reference system, or a coordinate system defined locally within the radar system. It should be noted that the orientation and the DOD are different quantities. The orientation of the transmitting radar node may be described by roll, pitch and heading angles, while the DOD is direction relative the transmitting radar node described e.g., by elevation and azimuth angles.

An advantage of determining orientation angle of said radar nodes is that it provides data regarding what orientation of said transmitting node that gives a specific DOD. Thus, the control circuitry may control the transmitting radar node and/or receiving radar node heading angle to provide navigation data from specific areas.

The radar system herein may be an airborne radar system, said transmitting and receiving radar node preferably being unmanned aerial vehicles (UAVs). It should also be noted that the radar system is a bistatic radar system in which the transmitting radar node and the receiving radar node are separated by a distance.

There is also provided a method herein, for monitoring a target relative a transmitting radar node and a receiving radar node and/or monitoring the transmitting radar node relative the receiving radar node. The method comprising the steps of transmitting MIMO signals, from a transmitting radar node, each MIMO signal having unique spatial signatures, wherein each spatial signature of said unique spatial signatures is associated to a specific transmitting direction (azimuth and elevation angle). The method further comprises receiving reflected signals from said transmitting node, the signals being received by a receiving radar node spatially separated relative the transmitting radar node, said signals being reflected from a target. The method further comprises determining DOA, and TOA of said signals reflected from the target and determining, based on the spatial signature of said reflected signal, DOD, of said signals. Furthermore, the method comprises deriving navigation data, based on the determined DOA, TOA and DOD, for monitoring the target relative the transmitting radar node and the receiving radar node and/or monitoring the transmitting radar node relative the receiving radar node.

For any aspect herein, the navigation data may allow the system/method to determine the position of the target relative the transmitting radar node and the receiving radar node and/or the position of the transmitting radar node relative the receiving radar node.

Also, it should be noted that the system may comprise a plurality of transmitting radar nodes, a plurality of receiving radar nodes for monitoring a plurality of targets. Thus, at least one of the plurality of receiving radar nodes may be configured to receive reflected signals from at least one of said plurality of transmitting nodes, said signals being reflected from at least one target. The control circuitry may thus be configured to determine DOA and TOA of said signals reflected from at least one target. The transmitting radar node may but is not limited to transmitting signals at specific pre-determined intervals known by the receiving radar node/control circuitry. Further, the control circuitry may determine, based on the spatial signature of each reflected signal, DOD of said signals and derive navigation data, based on the determined DOA, TOA and DOD, for monitoring at least one target relative at least one of the plurality of transmitting radar nodes and at least one of the receiving radar nodes and/or monitoring the at least one transmitting radar node relative the at least one receiving radar node. Thus, the system may monitor a plurality of targets relative a cluster of transmitting and receiving radar nodes and/or a cluster of transmitting radar nodes relative a cluster of receiving radar nodes. Accordingly, each transmitting radar node may have different unique spatial signatures relative other transmitting radar nodes in the system, allowing for the control circuitry to distinguish and monitor said plurality of transmitting radar nodes.

There is also provided a computer-readable storage medium storing one or more programs configured to be executed by one or more control circuitry, the one or more programs including instructions for performing the method herein. Thus, the method herein may be a computer implemented method.

Generally, all terms used in the description are to be interpreted according to their ordinary meaning in the technical field, unless explicitly defined otherwise herein. All references to “a/an/the [circuitry, node, device etc.]” are to be interpreted openly as referring to at least one instance of said circuitry, node, device, etc., unless explicitly stated otherwise.

### BRIEF DESCRIPTION OF THE DRAWINGS

These and other features and advantages of the present disclosure will now be further clarified and described in more detail, with reference to the appended drawings;

FIG. 1 schematically illustrates a system in accordance with some embodiments herein;

FIG. 2 schematically illustrates a system in accordance with some embodiments herein in which the system is monitoring a target relative a transmitting radar node and a receiving radar node;

FIG. 3 schematically illustrates a system in accordance with some embodiments herein in which the system is monitoring a target relative a transmitting radar node and a receiving radar node;

FIG. 4 schematically illustrates navigation data and navigation data after adding external navigation data;

FIG. 5 schematically illustrates a system comprising a plurality of nodes monitoring a plurality of targets; and

FIG. 6 illustrates in the form of a flow chart a method for monitoring a target relative a transmitting radar node and a receiving radar node and/or monitoring the transmitting radar node relative the receiving radar node.

### DETAILED DESCRIPTION

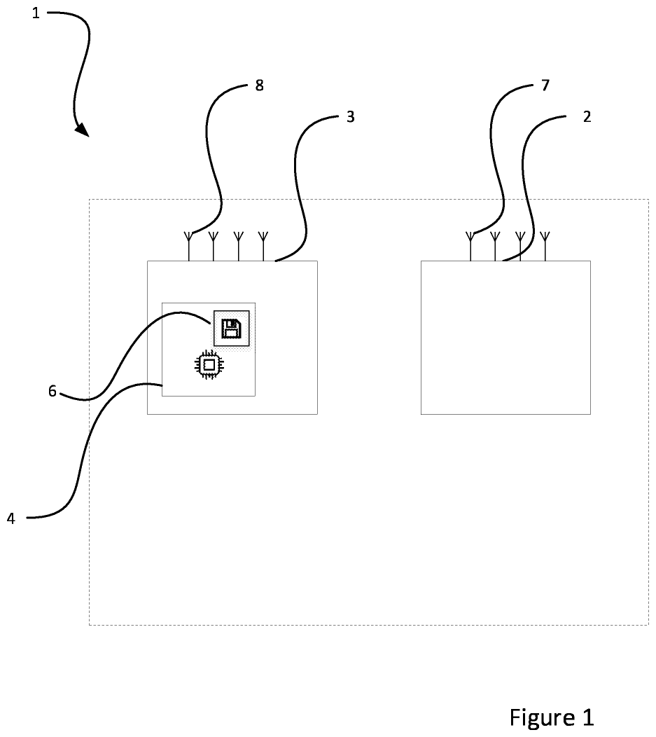

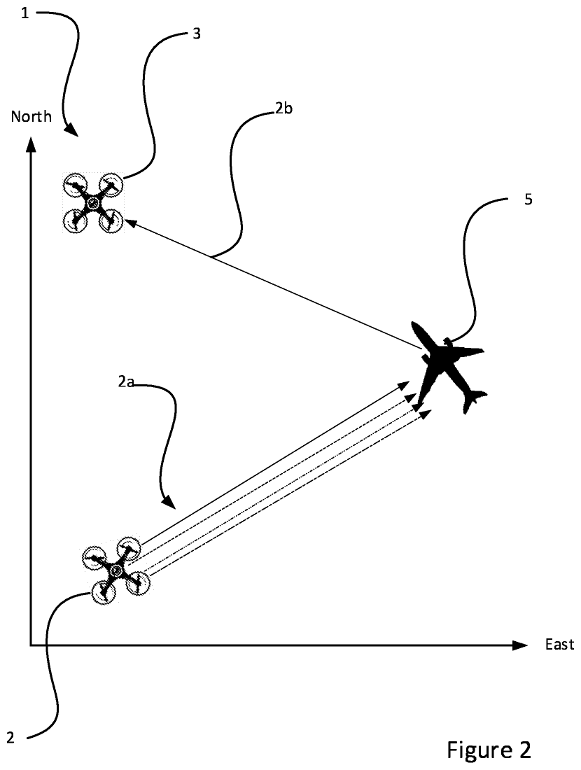

FIG. 1 schematically illustrates a multistatic radar system 1 comprising a transmitting radar node 2 configured to transmit MIMO signals 2a (seen in FIG. 2), each MIMO signal having unique spatial signatures, wherein each spatial signature of said unique spatial signatures is associated to a specific transmitting direction. Further, the system 1 comprises a receiving radar node 3 being spatially separated relative the transmitting radar node 2. Moreover, the system 1 comprises control circuitry 4. The control circuitry 4 may be within the receiving radar node 3, or externally provided. Moreover, FIG. 1 illustrates that the transmitting radar node 2 comprises a plurality of transmitting antenna elements 7 and the receiving radar node comprises a plurality of receiving antenna elements 8.

As illustrated in FIG. 1, the control circuitry 4 may comprise one or more memory devices 6. The memory devices 6 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by e.g., the control circuitry 4. Each memory device 6 may store any suitable instructions, data or information, including a computer program, software, an application including one or more of logic, rules, code, tables, etc. and/or other instructions capable of being executed by the control circuitry 4 and, utilized. Memory devices 6 may be used to store any calculations made by control circuitry 4 and/or any data received via interfaces of the control circuitry 4.

Each memory device 6 may also store data that can be retrieved, manipulated, created, or stored by the control circuitry 4. The data may include, for instance, spatial signature data, DOD data, DOA data, TOA data, The data may be stored in one or more databases. The one or more databases can be connected to the server by a high bandwidth field area network (FAN) or wide area network (WAN), or can also be connected to server through any other communication network.

The control circuitry 4 may include, for example, one or more central processing units (CPUs), graphics processing units (GPUs) dedicated to performing calculations, and/or other processing devices. The control circuitry 4 may further comprise a DOA deriving module, a DOD deriving module and a TOA deriving module respectively so to utilize each module to monitor the target in accordance with the method herein. The DOA deriving module may utilize any suitable parametric or spectral method for deriving DOA, e.g., Delay-and-sum method, multiple signal classifier method, Capons method or any other suitable method. The TOA deriving module may utilize e.g., matched filter technique method to derive TOA, or any other suitable TOA deriving technique. Calculations may be e.g., calculations for defining clock differences, TOA, DOD, DOA or navigation data. The memory device 6 can include one or more computer-readable media and can store information accessible by the control circuitry 4, including instructions/programs that can be executed by the control circuitry 4.

The expression “each MIMO signal” may refer to a transmitting radar node being configured to individually (for each antenna element) select e.g., the different signals (simultaneously) transmitted on each antenna element in the array antenna.

The expression “Time of arrival (TOA)” may refer to a time at which a given signal is detected by the receiving node 2. The TOA is calculated as the time of transmission from the transmitting radar node 2 added to the delay due to signal travel time to the receiving radar node 3.

The expression “direction of arrival (DOA)” may refer to the direction from which a signal arrives to the receiving radar node 3 and the expression “direction of departure (DOD)” may refer to the direction from which a signal leaves the transmitting radar node 2.

The term “monitoring” as used herein may refer to navigating, determining the position of or any combination thereof.

The term “spatial signature” may refer to a time-dependent coherent sum of different transmitted signals from an antenna array, e.g. at a target or at the receiving radar node. For example, an antenna array with 12 antenna elements in which each (or at least a plurality, or at least one) of the antenna elements transmit an individual/unique signal different from the signal transmitted from the other antenna elements (e.g. by different/separate/individual modulations on each antenna element), the time-dependent coherent sum of said signals form a spatial signature associated to a specific transmitting direction. Thus, spatial signature may be a time-dependent coherent sum of individual signals transmitted from each antenna element of a transmitting radar node, wherein each, or at least a plurality of the antenna elements transmit a signal different from the other antenna elements. In some aspects, the transmitting radar node may re-modulate at least one of the plurality of antenna elements for each subsequently transmitted MIMO signal or each group of subsequently transmitted MIMO signals.

FIG. 2 schematically illustrates the system 1 wherein the receiving radar node 3 is configured to receive reflected (MIMO) signals 2b from said transmitting node 2, said signals 2b being reflected from a target 5. The control circuitry (not showed in FIG. 2) is configured to determine DOA, and TOA of each said (MIMO) signals reflected from the target 5. Also, determine, based on the spatial signature of said reflected signal, DOD, of each of said signals. Moreover, the control circuitry is configured to derive navigation data, based on the determined DOA, TOA and DOD, for monitoring the target 5 relative the transmitting radar node 2 and the receiving radar node 3 and/or monitoring the transmitting radar node 2 relative the receiving radar node 3. Thus, as shown in FIG. 2, the transmitting radar node 2 may transmit a MIMO signal 2a. Each MIMO signal 2a may obtain a specific spatial signature as indicated in FIG. 2 in which each antenna element transmits differently modulated signals (indicated in FIG. 2 by different arrow types). The control circuitry 4 may pre-store the specific angles (DOD) associated to each spatial signature. Thus, as the receiving radar node 3 receives the reflected signal 2b, the control circuitry 4 may obtain data of that the signal is received, and determine the spatial signature thereof (by processing the MIMO signal, which comprises signals from each antenna element, at the receiving radar node), based on the spatial signature, the control circuitry 4 may determine DOD.

The MIMO signals may comprise unique spatial signatures by signal modulation, modulations being one of: frequency modulation, amplitude modulation, phase modulation or any other suitable type of modulation. Thus, a specific spatial signature may be correlated to a specific DOD.

As illustrated in FIG. 2 the transmitting and receiving radar nodes may be airborne radar nodes such as unmanned aerial vehicles.

Further, DOA and DOD each may be determined in azimuth angle and elevation angle. In FIG. 2 there is only visible azimuth.

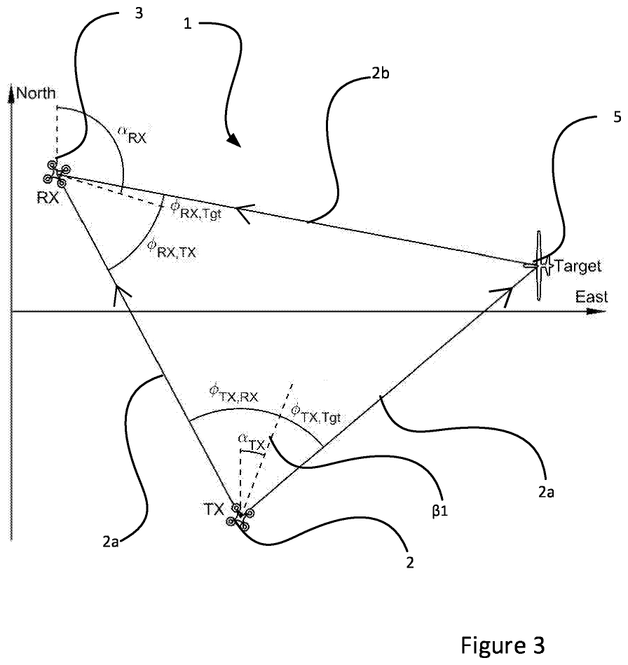

FIG. 3 illustrates schematically the system 1 during use in accordance with some aspects herein. FIG. 3 illustrates that said transmitting radar node 2 may further be configured to transmit signals 2a directly to said receiving radar node 3 and the control circuitry (not shown) is further configured to determine DOA and TOA of said directly transmitted signals and determine, based on the spatial signature of said directly transmitted signal 2a, DOD of said directly transmitted signals 2a relative the target. The control circuitry may be configured to, for each signal received, distinguish between reflected signals 2b and signals 2a directly transmitted to the receiving radar node 3. In other words, determine whether the signal is a direct signal 2a or a reflected signal 2b. The control circuitry may distinguish by e.g. calculating power or other factors of the received signal.

The system 1 may further be configured to, prior to/in addition to calculating navigation data estimate, based on said reflected signals 2b and said signals 2b transmitted directly to said receiving node 3, a clock difference of said transmitting radar node 2 and said receiving radar node 3. In other words, each node 2, 3 may comprise an internal clock noting a timing of when each signal is received/transmitted. The system 1 herein may provide synchronization of said clocks or calculate navigation data accounting for/considering said clock difference, so that time stamps of each clock are aligned, thereby e.g., the exact TOA may be determined for a signal giving a more accurate determining of navigation data. It should be noted that the clock difference may be determined also by receiving a plurality of reflected signals 2a from a plurality of targets 5, wherein said control circuitry is configured to, prior to/in addition to calculating navigation data estimate, based on said plurality of reflected signals 2a, a clock difference of said transmitting radar node 2 and said receiving radar node 3.

FIG. 3 further illustrates orientation angles of the transmitting and receiving radar node 2, 3. The navigation data may comprise said orientation angles. The navigation data may further comprise position of said receiving radar node 3 relative said transmitting radar node 2 and/or said target 5. The orientation angles may comprise roll and pitch angles (not shown) relative a reference direction/point and also comprise heading angles α^{TX}, α^{RX} of each node 2, 3 relative a reference point/direction which in FIG. 3 is the north direction. In FIG. 3 only the heading angles α^{TX}, α^{RX} are illustrated. Accordingly, as illustrated in FIG. 3, DOD (for the reflected signal) may be defined as an angle between an antenna normal β1 of each node and the target ø^{TX,tgt}.ø^{RX,tgt}. Thus, the heading angles α^{TX}, α^{RX} may therefore as shown in FIG. 3 be an angle between the antenna normal β1 and a (fixed) reference direction/point. Thus, orientation angles may be derived based on DOD and/or DOA. FIG. 3 illustrates azimuth angles however DOD is also derived for elevation angles in the present disclosure.

Thus, based on the navigation data the system 1 may determine the position of the target 5 relative the receiving radar node 3 and the transmitting radar node 2.

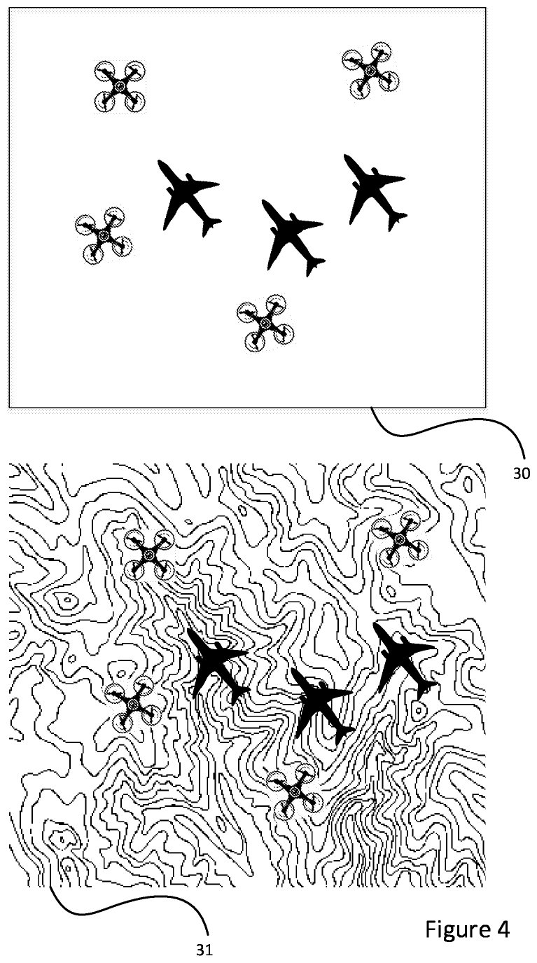

FIG. 4 illustrates schematically an internal positioning map 30 and an internal positioning map 31 supplied with external navigation data. Accordingly, the control circuitry 4 may provide an internal positioning map 30 that comprises the position of the receiving radar node, 3, transmitting radar node 2 and target 5 relative each other. The control circuitry 4 may provide the internal positioning for a display unit (not shown). The control circuitry 4 may as shown in 31 populate the internal positioning map 30 with external navigation data 31.

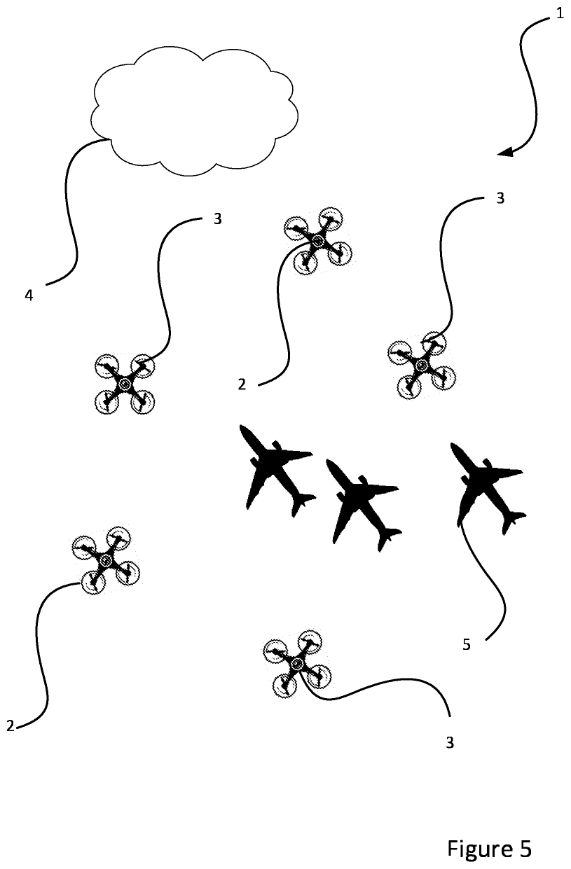

FIG. 5 illustrates that the system 1 may comprise a plurality of transmitting radar nodes 2 and a plurality of receiving radar nodes 3 and may monitor a plurality of targets 5. Moreover, as illustrated in FIG. 5 the control circuitry 4 may be an external control circuitry 4 e.g. in a cloud computing server. Thus, the system of any aspect herein may be directed for monitoring a plurality of targets 5.

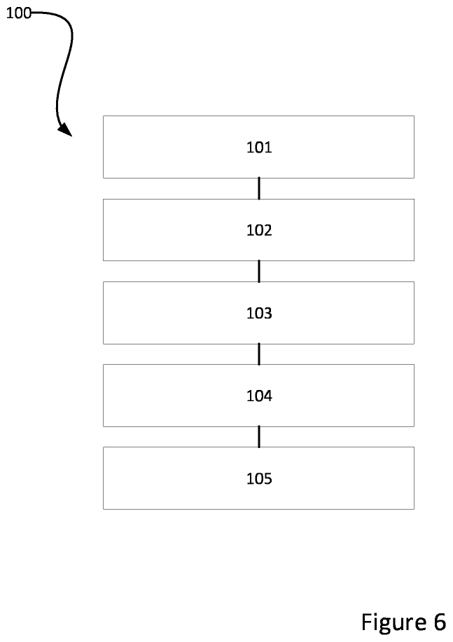

FIG. 6 illustrates a method 100 for monitoring a target relative a transmitting radar node and a receiving radar node and/or monitoring the transmitting radar node relative the receiving radar node. The method 100 comprising the steps of transmitting 101 MIMO signals, from a transmitting radar node, each MIMO signal having unique spatial signatures, wherein each spatial signature of said unique spatial signatures is associated to a specific transmitting direction. Moreover, the method 100 may comprise the step of receiving 102 reflected signals from said transmitting node, the signals being received by a receiving radar node spatially separated relative the transmitting radar node, said signals being reflected from a target. The method 100 may further comprise determining 103 DOA, and TOA of said signals reflected from the target, and determining 104, based on the spatial signature of said reflected signal, DOD of said signals. The method 100 may further comprise the step of deriving 105 navigation data, based on the determined DOA, TOA and DOD, for monitoring the target relative the transmitting radar node and the receiving radar node and/or monitoring the transmitting radar node relative the receiving radar node.

The method 100 may perform any other step that the control circuitry 4 according to any aspect herein is configured to perform. There is further provided a computer-readable storage medium storing one or more programs configured to be executed by one or more control circuitry 4, the one or more programs including instructions for performing the method 100 according to any aspect of the present disclosure.

1. A multistatic radar system comprising:
a transmitting radar node configured to transmit MIMO signals, each MIMO signal having unique spatial signatures, wherein each spatial signature of said unique spatial signatures is associated to a specific transmitting direction;
a receiving radar node being spatially separated relative the transmitting radar node;
control circuitry;
wherein the receiving radar node is configured to:
receive reflected signals from said transmitting node each reflected signal being reflected from a target wherein said control circuitry is configured to:
determine direction of arrival, DOA, and time of arrival, TOA of each of the signals reflected from the target;
determine, based on the spatial signature of each reflected signal, direction of departure, DOD, of said signal; and
derive navigation data, based on the determined DOA, TOA and DOD, for monitoring the target relative the transmitting radar node and the receiving radar node and/or monitoring the transmitting radar node relative the receiving radar node

2. The multistatic radar system according to claim 1, wherein the signals comprise unique spatial signatures by signal modulation, modulations being one of: frequency modulation, amplitude modulation, phase modulation or any other suitable type of modulation.

3. The multistatic radar system according to claim 1, wherein said transmitting radar node is further configured to:
transmit signals directly to said receiving radar node;
the control circuitry being further configured to:
determine DOA and TOA of said directly transmitted signals; and
determine, based on the spatial signature of said directly transmitted signal, DOD of said directly transmitted signals relative the target.

4. The multistatic radar system according to claim 3, wherein said receiving radar node is configured to, in addition to calculating navigation data:
estimate, based on said reflected signals and said signals transmitted directly to said receiving node, a clock difference of said transmitting radar node and said receiving radar node.

5. The multistatic radar system according to claim 1, wherein said receiving radar node is configured to:
receive a plurality of reflected signals from a plurality of targets;
wherein said control circuitry is configured to, in addition to calculating navigation data:
estimate, based on said plurality of reflected signals, a clock difference of said transmitting radar node and said receiving radar node.

6. The multistatic radar system according to claim 1, wherein DOA and DOD are each determined in azimuth angle and elevation angle.

7. The multistatic radar system according to claim 1, wherein the navigation data comprises:
orientation angles of said transmitting and/or receiving radar node, respectively; and
position of said receiving radar node relative said transmitting radar node and/or said target,
wherein the orientation angle comprise roll, pitch and heading angles of each node.

8. The multistatic radar system according to claim 1, wherein said radar system is an airborne radar system, said transmitting and receiving radar node being unmanned aerial vehicles, UAVs.

9. A method for monitoring a target relative a transmitting radar node and a receiving radar node and/or monitoring the transmitting radar node relative the receiving radar node, the method comprising:
transmitting MIMO signals, from a transmitting radar node, each MIMO signal having unique spatial signatures, wherein each spatial signature of said unique spatial signatures is associated to a specific transmitting direction;
receiving reflected signals from said transmitting node, the signals being received by a receiving radar node spatially separated relative the transmitting radar node, each signal being reflected from a target;
determining direction of arrival, DOA, and time of arrival, TOA of each signal reflected from the target;
determining, based on the spatial signature of each reflected signal, direction of departure, DOD, of said signal; and
deriving navigation data, based on the determined DOA, TOA and DOD, for monitoring the target relative the transmitting radar node and the receiving radar node and/or monitoring the transmitting radar node relative the receiving radar node.

10. A computer-readable storage medium storing one or more programs configured to be executed by one or more control circuitry, the one or more programs including instructions for performing the method of claim 9.
